(19) United States
(12) Patent Application Publication
(10) Pub. No.: US 2007/0044056 A1
(43) Pub. Date: Feb. 22, 2007

(54) Macro block placement by pin connectivity

(75) Inventors: Michael A. Minter, Bowling Green, KY (US); Donald R. Amundson, New Prague, MN (US); Donald Gabrielson, Rochester, MN (US)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 11/204,514

(22) Filed: Aug. 16, 2005

(51) Int. Cl. G06F 17/50

(52) U.S. Cl. 716/8

(57) ABSTRACT

A design tool includes a first module, a second module, a third module and a fourth module. The first module may be configured to select a platform for implementing an integrated circuit design in response to input from a user. The second module may be configured to select a macro block to be placed on the platform in response to input from the user. A description of the macro block may be configured to indicate whether the macro block has connectivity placement data. The third module may be configured to determine whether the macro block has the connectivity placement data based on the description of the macro block. The fourth module may be configured to automatically place the macro block on the platform based on the connectivity placement data, when the description of the macro block indicates the connectivity placement data is present.

### FIELD OF THE INVENTION

The present invention relates to application specific integrated circuit (ASIC) design generally and, more particularly, to a method for macro block placement by pin connectivity.

### BACKGROUND OF THE INVENTION

Conventional techniques for placing a macro block involve a trial and error process. Various checks and simulations are run to determine whether the macro block has a proper placement. If the placement is not valid, the cycle must be repeated. The conventional approaches are manual, time consuming and often iterative.

Placement of macro blocks on an application specific integrated circuit (ASIC) often involves hundreds, or even thousands, of pins which must be connected. When a designer places the macro block, a conventional placement approach is to view all of the macro block pin connections on the chip to visually see the macro block/chip connections. The designer tries to shorten the connections to the highest number of macro block pins. In the conventional placement approach all macro block pin connections are given the same weight or priority. However, giving the same weight or priority to all macro block pin connections does not take into account that some of the macro block nets can have a higher priority, or more critical timing path. With the conventional methodology, the designer can be unaware that a macro block has higher priority IO. Additionally, the designer can be unaware that a problem exists with the placement of a macro block until numerous time consuming checks are performed.

It would be desirable to have a method for macro block placement by pin connectivity.

### SUMMARY OF THE INVENTION

The present invention concerns a design tool that includes a first module, a second module, a third module and a fourth module. The first module may be configured to select a platform for implementing an integrated circuit design in response to input from a user. The second module may be configured to select a macro block to be placed on the platform in response to input from the user. A description of the macro block may be configured to indicate whether the macro block has connectivity placement data. The third module may be configured to determine whether the macro block has the connectivity placement data based on the description of the macro block. The fourth module may be configured to automatically place the macro block on the platform based on the connectivity placement data, when the description of the macro block indicates the connectivity placement data is present.

The objects, features and advantages of the present invention include providing a method for macro block placement by pin connectivity that may (i) reduce the cycle time of placing macro blocks on ASIC chips, (ii) provide automatic placement of macro blocks, (iii) include placement method information in macro block description, (iv) include pin connectivity information in macro description and/or (v) provide optimized placement for each macro block.

### BRIEF DESCRIPTION OF THE DRAWINGS

These and other objects, features and advantages of the present invention will be apparent from the following detailed description and the appended claims and drawings in which:

FIG. 1 is a block diagram illustrating an example of an application specific integrated circuit;

FIG. 2 is a block diagram illustrating an example of a data structure in accordance with a preferred embodiment of the present invention;

FIG. 3 is a flow diagram illustrating an example of a design flow in accordance with a preferred embodiment of the present invention; and

FIG. 4 is a flow diagram illustrating an example of an automatic placement process in accordance with the present invention.

### DETAILED DESCRIPTION OF THE PREFERRED EMBODIMENTS

The present invention generally enhances the current design methodology by facilitating automation of the placement process. The present invention may provide more accurate results. Macro block descriptions in accordance with the present invention contain new information indicating whether the macro block includes placement data based on pin connectivity (e.g., placement by connectivity data). When the macro block description indicates availability of placement by connectivity data, the macro block description also specifies the placement by connectivity data. In one example, extensible mark-up language (XML) may be used to specify the placement by connectivity data. XML is an industry standard format that can be used to deliver macro block connectivity data. However, other standard or proprietary formats may be implemented accordingly without departing from the spirit and scope of the present invention.

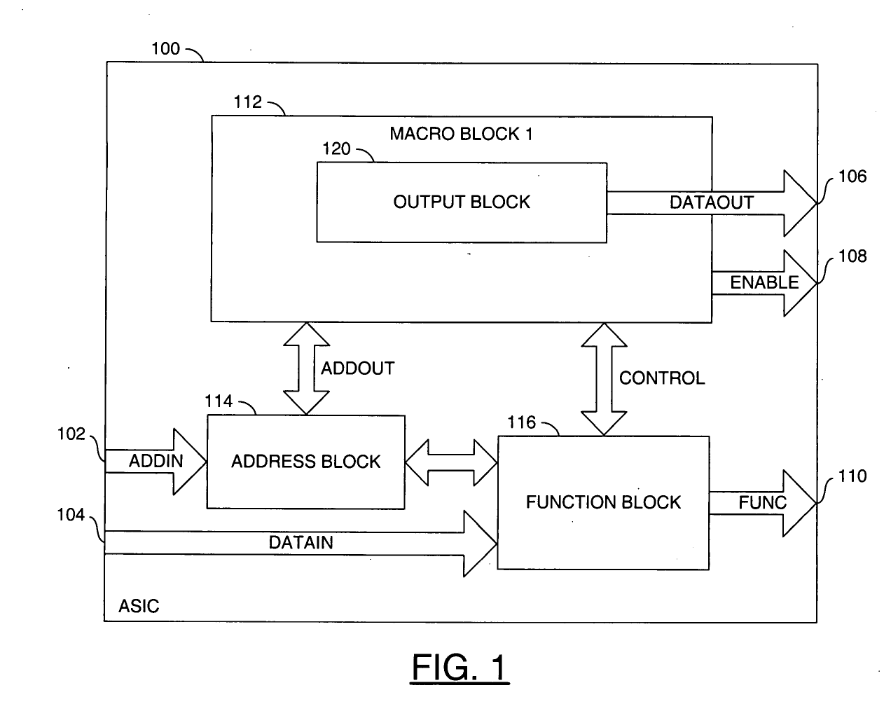

Referring to FIG. 1, a block diagram is shown illustrating an example macro block placement on a die (or chip) 100. In one example, the die 100 may be implemented as an application specific integrated circuit (ASIC) or an application specific standard product (ASSP). In one example, the die may be implemented as a standard cell ASIC, a semi-custom ASIC, a full custom ASIC or a structured/platform ASIC.

In one example, the die 100 may have a number of input pins 102 configured to receive a first input signal (e.g., ADDIN) and a number of input pins 104 configured to receive a second input signal (e.g., DATAIN). In one example, the signal ADDIN may be implemented as an address signal. In one example, the signal DATAIN may be implemented as a data signal. In one example, the signals ADDIN and DATAIN may be implemented as multi-bit signals.

The die 100 may also have a number output pins 106 that may be configured to present a first output signal (e.g., DATAOUT), an output pin 108 configured to present a second output signal (e.g., ENABLE) and an output pin 110 configured to present a third output signal (e.g., FUNC). In one example, the signal DATAOUT may be implemented as a data signal. In one example, the signal ENABLE may be implemented as an enable (or control) signal. In one example, the signal FUNC may be implemented as a function (or control) signal. In one example, the signal DATAOUT may be implemented as a multi-bit signal.

In one example, a macro block 112, an address block 114 and a function block 116 may be placed on the die 100. The block 112 may have a first output that may present the signal DATAOUT, a second output that may present the signal ENABLE, a first input/output configured to couple the macro block 112 to the address block 114 (e.g., via a signal ADDOUT) and a second input/output configured to couple the macro block 112 to a first input/output of the function block 116 (e.g., via a signal CONTROL). The address block 114 may also have an input that may receive the signal ADDIN and a second input/output configured to couple the address block 114 to a second input/output of the function block 116. The function block 116 may also have an output that may present the signal FUNC. In one example, the macro block 112 may comprise an output block 120 that may be configured to present the signal DATAOUT. The signals ADDOUT and CONTROL may be implemented as single or multi-bit signals.

In general, the macro block 112 may be placed on the die 100 according to a number of placement modes. In one example, the macro block 112 may be placed using a pin connectivity mode. In another example, the macro block 112 may be placed using a cell connectivity mode. In the pin connectivity mode, the macro block 112 may be placed based on information regarding the connections between the macro block 112 and the pins 106 and 108. In the cell connectivity mode, the macro block 112 may be placed based on information regarding connections between the macro block 112 and the address block 114 and the function block 116. The address block 114 and the function block 116 may be placed using a similar methodology.

In one example, block (or cell) descriptions may be implemented in accordance with the present invention for the blocks 112, 114 and 116. The block descriptions may contain placement mode and connection information that may be configured to allow a design tool to automatically place the blocks 112, 114 and 116. In one example, the block descriptions may comprise extensible mark-up language (XML) listings that may be used to develop connectivity data for the blocks 112, 114 and 116. For example, the macro block 112 of FIG. 1 may have a block description comprising (or associated to) XML formatted connectivity placement information similar to the following listing:

<placementinfo>

<cellName>MacroBlock1</cellName>

<placementMethod>pinconnectivity</placementMethod>

<placementPinInfo>

<placementPin>DATAOUT</placementPin>

</placementPinInfo>

</placementInfo>

<placementInfo>

<Celllname>addressBlock</cellname>

<placementMethod>Cellconnectivity</placementMethod>

<placementCellInfo>

<placementCell>MacroBlock1</placementCell>

</placementCellInfo>

</placementInfo>

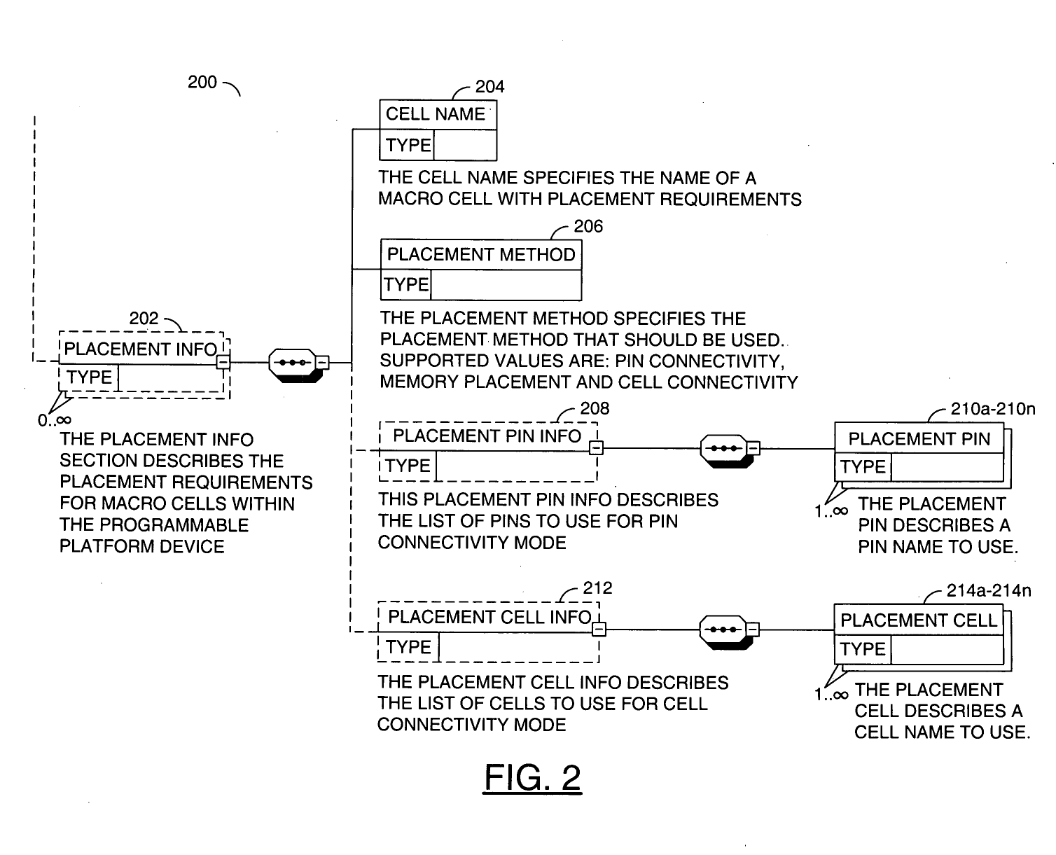

Referring to FIG. 2, a block diagram is shown illustrating an example of an extensible mark-up language (XML) schema that may be used to develop connectivity data in accordance with a preferred embodiment of the present invention. In one example, an intellectual property (IP) block may be described by an XML scheme 200. The XML scheme 200 may comprise a block 202, a block 204, a block 206, a block 208, a number of blocks 210a-210n, a block 212 and a number of blocks 214a-214n. In one example, the block 202 may comprise placement information. The block 204 may comprise cell name information. The block 206 may comprise placement method information. The block 208 may comprise placement pin information. The blocks 210a-210n may comprise placement pin information. The block 212 may comprise placement cell information. The blocks 214a-214n may comprise placement cell name information.

In one example, the block 202 may comprise placement information describing the placement specifications for macro blocks (or cells) within the integrated circuit (IC) design. The block 204 may be configured to specify a name of a macro cell with placement specifications. The block 206 may comprise information specifying a placement method that should be used for a particular macro block. For example, the placement method information block 206 may comprise information specifying pin connectivity, memory placement and/or cell connectivity as the basis (or mode) for placing the macro block. The block 208 may comprise placement pin information describing a list of pins that may be used for the pin connectivity mode. The blocks 210a-210n may comprise placement pin name information for each pin involved in the placement of the macro block. For example, each of the blocks 210a-210n may comprise information configured to describe a pin name that may be used in connection with the pin information. The block 212 may contain placement cell information describing a list of cells (or macro blocks) that may be used for the cell connectivity mode. The blocks 214a-214n may comprise placement cell name information describing a cell name that may be used in connection with a particular cell.

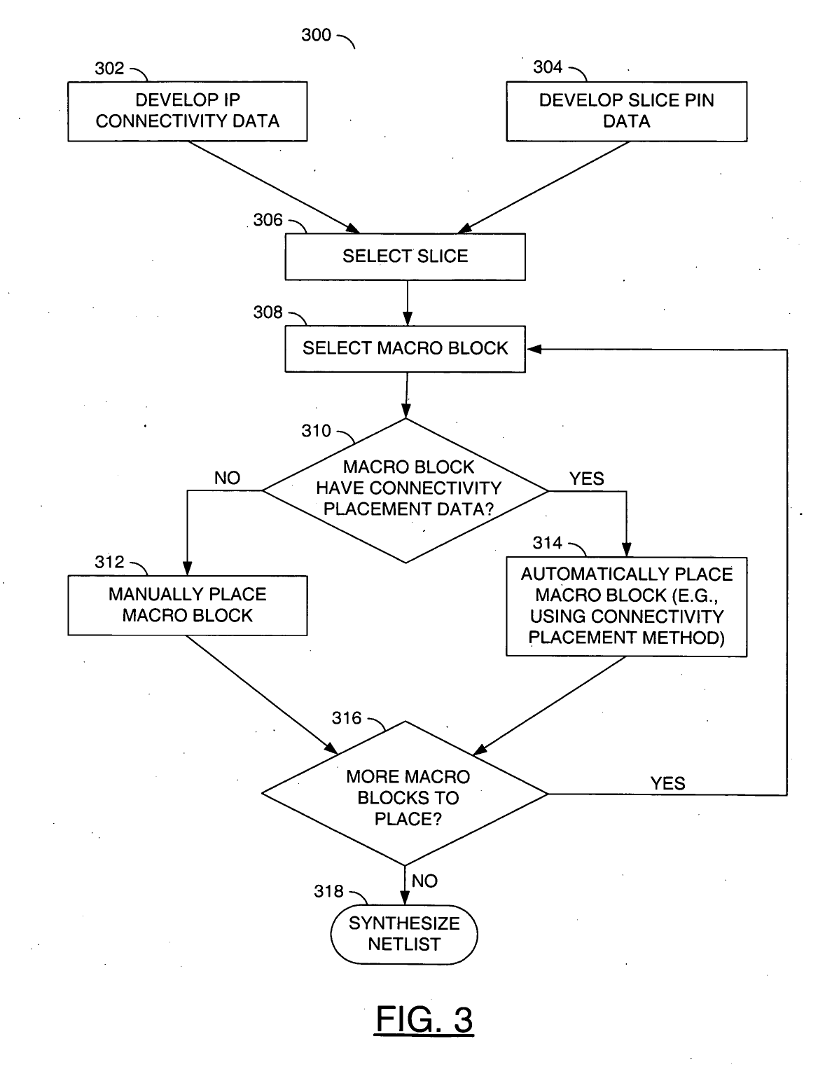

Referring to FIG. 3, a flow diagram is shown illustrating a placement process 300 in accordance with a preferred embodiment of the present invention. In one example, the process 300 may comprise a block 302, a block 304, a block 306, a block 308, a block 310, a block 312, a block 314, a block 316 and a block 318. The block 302 may comprise developing (or extracting) IP connectivity data. The block 304 may comprise developing (or extracting) slice pin data. The block 306 may comprise selecting a particular slice for development of an application specific integrated circuit (ASIC). The block 308 may comprise selecting a macro block for placement on the selected slice. The block 310 may comprise checking for connectivity placement data. The block 312 may comprise manually placing a selected macro block. The block 314 may comprise automatically placing a selected macro block. The block 316 may comprise determining whether all macro blocks are placed. The block 318 may comprise synthesizing a netlist.

In one example, a design flow of an integrated circuit may begin with development of IP connectivity data (e.g., block 302) and slice (or platform) pin data (e.g., block 304). The IP connectivity data and/or slice pin data may be developed (or specified) prior to the integrated circuit design flow or at the beginning of the integrated circuit design flow. Both the IP connectivity data and the slice pin data may be fed into the design flow where the designer selects a slice for implementing the integrated circuit design (e.g., block 306). After the slice is selected, the designer may select one or more macro blocks to be included in the integrated circuit design. Each of the macro blocks may comprise design data including placement connectivity data in accordance with the present invention.

As used herein, the term slice generally refers to a partially manufactured semiconductor device in which the wafer layers up to the connectivity layers have been fabricated. The slice generally comprises a base semiconductor wafer (e.g., from silicon, silicon-on-insulator, silicon germanium, gallium arsenide, other Type II, III, IV, and V semiconductors, etc.). The slice generally comprises a piece of semiconductor material into which blocks or hardmacs have been diffused into the semiconductor layers. Diffusing a semiconductor wafer to create a hardmac simply means that during fabrication of the wafer layers, transistors or other electronic devices have been particularly arranged in the wafer layers to achieve specific functions, such as diffused memory, data transceiver hardware (e.g., I/O PHYs), clock factories (e.g., PLLs, etc.), control I/Os, configurable input/output (I/O) hardmacs, etc. Each of the hardmacs generally has an optimum arrangement and density of transistors to realize a particular function. The slice may further comprise an area of transistor fabric for further development of the slice using a suite of generation tools. The transistor fabric generally comprises an array of prediffused transistors in a regular pattern that can be logically configured by placement of one or more metal layers. Different slices may contain different amounts and arrangements of transistor fabric, different amounts of diffused and/or compiled memories, both fixed and configurable I/O blocks, clocks, etc. depending upon the purpose of the final integrated chip.

The design data for the selected macro blocks may be analyzed to determine whether the macro block design data includes placement connectivity data (e.g., block 310). When the macro block design data does not include placement connectivity data, the process 300 may enter a manual placement mode (e.g., the NO path from the block 310 to the block 312). In the manual placement mode, the designer manually places the macro block onto the slice to the best of his/her ability. When the macro block design data includes placement connectivity data, the process 300 may enter an automatic placement mode (e.g., the YES path from the block 310 to the block 314). In the automatic placement mode, a design tool may be configured to place the macro block onto the slice based on connectivity placement information (e.g., pin connectivity data, etc.) extracted from the macro block description.

When the macro block has been placed, either manually or automatically, the process 300 determines whether any macro blocks remain to be placed (e.g., block 316). When there are no more macro blocks to be placed, the process 300 moves to the block 318. In the block 318, a netlist may be synthesized (e.g., using conventional synthesis tools). When more macro blocks remain to be placed, the process 300 generally returns to the block 308 to select the next macro block for placement (e.g., the YES path from the block 316 to the block 308).

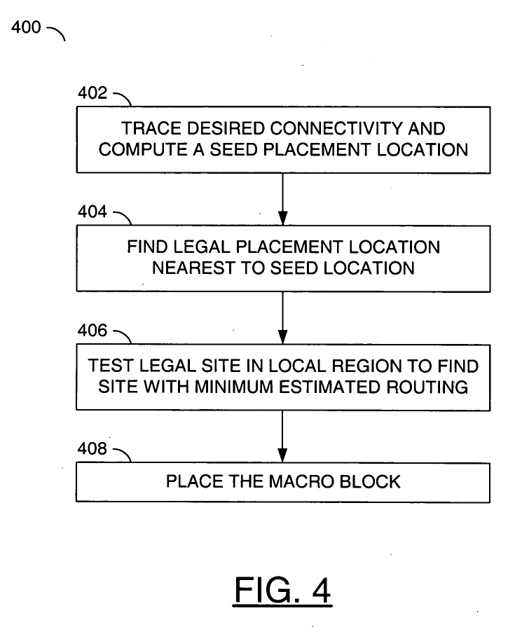

In general, when the macro block design data includes placement connectivity data, the slice pin data is gathered (or extracted) and automatic placement may be performed. In one example, automatic placement may be performed using a connectivity placement process as described below in connection with FIG. 4.

Referring to FIG. 4, a flow diagram is shown illustrating an example of an automatic placement process 400 in accordance with a preferred embodiment of the present invention. The process 400 may comprise a block (or state) 402, a block (or state) 404, a block (or state) 406 and a block (or state) 408. The block 402 may comprise tracing desired connectivity and computing a seed placement location. The block 404 may comprise finding the nearest legal placement location (or site) to the seed location determined in the block 404. The block 406 may comprise testing the legal site in a local region to find a site with minimum estimated routing. The block 408 may comprise placing the macro block based on the site with the minimum estimated routing found in the block 406.

Automated placement of the macro block is generally performed using the specified method of either pin connectivity or cell connectivity. The first step in automated placement is to find a starting seed placement location. The starting seed placement location may be found, for example, by tracing the netlist connectivity of the macro block to determine which other design cells are connected to the macro block. When the connectivity is traced, only those connections that match the specified placement method are considered in the search.

For example the macro block 112 has (i) an output (or pins) DATAOUT connected to die (or chip) DATAOUT pins 106, (ii) an output (or pin) ENABLE connected to chip ENABLE pin 108, (iii) an input/output (or pins) ADDOUT connected to the block 114 and (iv) an input/output (or pins) CONTROL connected to the block 116. If the block 112 is placed using the pin connectivity mode with the placement pin parameter set to DATAOUT, only the connectivity to the chip DATAOUT pin 106 would be traced. The other connections would be ignored.

In another example, the block 114 has (i) an input/output (or pin) ADDOUT connected to the block 112, (ii) an input (or pins) ADDIN connected to the chip pins 102 and (iii) an input/output (or pins) connected to an input/output (or pins) of the block 116. If the block 114 is placed using the cell connectivity mode with the placement cell info parameter set to MacroBlock1, only the connection via ADDOUT to the block 112 would traced.

As the connectivity is traced to the specified connections, a placement seed coordinate may be computed by averaging the coordinate values of the placement location of each of the connected pin locations. For example, for the block 112 the average location of the chip DATAOUT pins 106 would be determined. With the placement seed computed, the nearest legal placement location on the die is found. As used herein, legal placement locations are those locations that satisfy the placement rules for the die (e.g., manufacturing rules, avoiding blocked areas, aligning to power meshes, rules for valid rotations, etc.).

When the nearest legal location is found, a search is performed for other placement locations near the starting location. The search is generally configured to find the best placement location. In one example, the best placement location may be determined as the location that has the minimum estimated routing length sum for all the desired connections. When the best location has been determined, the macro block is generally placed at the best location.

In one example, the macro block placement connectivity data may provide a prioritized pin placement list. When the macro block connectivity data provides a prioritized pin placement list, the automatic placement is generally optimized for performance. The cycle may be repeated for each macro block to be placed. When all of the macro blocks are placed, the netlist may be synthesized.

The function performed by the flow diagrams of FIGS. 3-4 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, ASSPs, FPGAs, or by interconnecting an appropriate network of conventional component circuits, as is described herein, modifications of which will be readily apparent to those skilled in the art(s).

The present invention thus may also include a computer product (e.g., a computer readable medium, etc.) which may be a storage medium including instructions which can be used to program a computer to perform a process in accordance with the present invention. The storage medium may also include design data and/or deliverables. In one example, deliverables, as used herein, may refer to one or more of code, logic, assembler code, and netlists. In another example, deliverables may also refer to layout information and even microcode for one or more cores. The storage medium can include, but is not limited to, any type of disk including floppy disk, optical disk, CD-ROM, magneto-optical disks, ROMs, RAMs, EPROMS, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. A design tool comprising:
a first module configured to select a platform for implementing an integrated circuit design in response to input from a user;
a second module configured to select a macro block to be placed on said platform in response to input from said user, wherein a description of said macro block is configured to indicate whether said macro block has connectivity placement data;
a third module configured to determine whether said macro block has said connectivity placement data based on said description of said macro block; and
a fourth module configured to automatically place said macro block on said platform based on said connectivity placement data, when said description of said macro block indicates said connectivity placement data is present.

2. The design tool according to claim 1, further comprising:
a fifth module configured to allow said user to manually place said macro block on said platform based on said connectivity placement data, when said description of said macro block indicates said connectivity placement data is not present.

3. The design tool according to claim 1, further comprising:
a sixth module configured to synthesize a netlist for said integrated circuit design.

4. The design tool according to claim 1, wherein said connectivity placement data comprises one or more types of data selected from the group consisting of pin connectivity data and cell connectivity data.

5. The design tool according to claim 4, wherein said pin connectivity data comprises a prioritized pin placement list.

6. The design tool according to claim 1, wherein said fourth module is further configured to gather pin data for said platform.

7. The design tool according to claim 1, further comprising:
a development module configured to generate said connectivity placement data for said macro block according to criteria for optimizing placement of said macro block.

8. A method for macro block placement based on pin connectivity comprising the steps of:
(A) selecting a platform for implementing an integrated circuit design;
(B) selecting a macro block to be placed on said platform, wherein a description of said macro block is configured to indicate whether said macro block has connectivity placement data;
(C) determining whether said macro block has said connectivity placement data based on said description of said macro block; and
(D) automatically placing said macro block on said platform based on said connectivity placement data, when said description of said macro block indicates said connectivity placement data is present.

9. The method according to claim 8, wherein steps C and D are repeated for each macro block placed on said platform.

10. The method according to claim 8, further comprising a step of:
manually placing said macro block on said platform based on said connectivity placement data, when said description of said macro block indicates said connectivity placement data is not present.

11. The method according to claim 8, further comprising the step of:
synthesizing a netlist for said integrated circuit design.

12. The method according to claim 8, wherein said connectivity placement data comprises one or more types of data selected from the group consisting of pin connectivity data and cell connectivity data.

13. The method according to claim 12, wherein said pin connectivity data comprises a prioritized pin placement list.

14. The method according to claim 8, wherein step D comprises:
gathering pin data for said platform.

15. The method according to claim 8, further comprising the step of:
developing said connectivity placement data for said macro block according to criteria for optimizing placement of said macro block.

16. A computer readable medium containing computer executable instruction for directing a general purpose computer to perform the method according to claim 8.

17. The computer readable medium according to claim 16, further comprising said description of said macro block.

18. A computer readable medium including computer readable data, wherein said data comprises:
deliverables describing one or more macro blocks;
an indicator for each of said one or more macro blocks, said indicator configured to indicate whether connectivity placement data is available for a respective one of said one or more macro blocks; and
said connectivity placement data that is available for said one or more macro blocks.

19. The computer readable medium according to claim 18, wherein said data further comprises:
deliverables describing one or more platforms on which said one or more macro blocks can be placed; and
pin connectivity data for said one or more platforms.
